(19) United States
(12) Patent Application Publication
(10) Pub. No.: US 2013/0018760 A1
(43) Pub. Date: Jan. 17, 2013

(54) System & method for organizing trade

(71) Applicant: Michael Barabash, Katonah, NY (US)

(72) Inventor: Michael Barabash, Katonah, NY (US)

(21) Appl. No.: 13/135,846

(22) Filed: Jul. 16, 2011

(51) Int. Cl. G06Q 30/00

(52) U.S. Cl. 705/26.61

(57) ABSTRACT

A method of organizing a trade includes introducing into an electronic data processing system by a plurality of users information about the users and about items which they are willing to sell, searching in the electronic data processing system by the same users of the plurality of users information about items which they are willing to buy, where, in the event that one of the plurality of users finds an item in the electronic data processing system which the one user is willing to buy, generating by the electronic data processing system a connection between an item to sell, information about which the one user introduced into the electronic data processing system, and the item to buy, information about which the one user found in the electronic data processing system. Based on connections so formed, finding by the electronic data processing system in the plurality of users a plurality of groups of users, such that in each of the groups of users all items of all users of each of the groups can be sold and bought exclusively by all the users within each of the groups.

### BACKGROUND OF THE INVENTION:

The invention relates broadly to trade and commerce and, more particularly relates to a system that enables users to enter and list information about items they wish to sell, search for other listed items for sale, links the users' roles as sellers of listed items with their roles as buyers of other users' listed items, and forms transaction or trade scenarios, which include a grouping of items in which all of the buyers and sellers of the respective items have listed one of the items in a role as a seller, and have selected one of the items to buy in a role of a buyer.

Trade is the business of buying and selling commodities (commerce), for example, an act or an instance of buying or selling (i.e., a transaction). In another sense, trade is the transfer of ownership of goods from one person or entity to another. A network that allows trade is called a market or exchange, where the common medium of exchange is money. Trade between two traders is called bilateral trade, while trade between more than two traders is called multilateral trade. Traditionally, one of the traders is a seller (i.e., he or she has the item for sale) and the other is the buyer (i.e., he or she wants to purchase the item for sale).

The types of goods traded today are innumerable. Any product or device imaginable is bought or sold in “brick and mortar” shops and stores, in on-line exchanges (websites directed to buying and/or selling) and traditional exchanges. In the field of real estate transactions, many real estate agents now utilize a network of terminals linked to a host computer which provides a database of listed properties. The agent can formulate a list of properties in which the buyer may be interested based on criteria provided by the buyer, such as price, location, size or type. The buyer can then view the property and, if interested, can contact the seller, or more usually, the seller's agent in order to initiate negotiations.

More recently, the global network commonly referred to as the “Internet” has been used to advertise particular pieces of property to potential buyers. Such uses are primarily limited to situations in which a seller advertises a particular piece of property by posting a listing on an “electronic bulletin board” which may be read by potential buyers. The buyers can then contact the seller or the seller's agent by telephone or by electronic mail. While some databases created by agents or brokers are available, access is usually limited, typically requiring the payment of a fee in order to gain authority to utilize the database.

A Multiple Listing Service (MLS) is a facility for the orderly correlation and dissemination of listing information on commercial and residential properties for sale to better serve listing broker or agent clients, customers and the public. A MLS database and software is used by real estate brokers representing sellers under a listing contract to widely share information about the commercial or residential properties with other brokers who may represent potential buyers or wish to cooperate with a seller's broker in finding a buyer for the property or asset.

Various methods and techniques are known to match buyers with sellers of various types of property. Instead of searching item by item to find a desired piece of property, a buyer searches the MLS database using certain criteria such as price, size or location. This permits the buyer to avoid spending time looking at property or listings which are of only tangential interest or no interest at all. In recent times, advances in data storage and retrieval methods and communications methods have permitted more sophisticated approaches to performing at least the initial step of matching buyers and sellers.

Once a property is found that interests a buyer, the buyer contacts the seller and the buyer and seller then attempt to agree on an amount to complete the transaction. Upon determining a fair price for the real-estate transaction, the buyer must meet the agreed to sales price. Oftentimes, a buyer is a current owner of another property and his/her ability to meet the agreed upon price for the new property is contingent upon sale of the other (old) property. That is, sale of the old property is a condition precedent to the buyer completing the transaction for purchase of the new property.

For that matter, there also is a time constraint in purchasing a property. That is, once a purchaser decides to purchase a commercial or residential property, they typically sign a contract and provide a down payment. The contract typically has a “time is of the essence” clause, whereby the buyer must present the entire purchase price and complete the transaction within a certain time period. If the buyer cannot do so because he/she is unable to sell their own home or business property (old), the seller may back out of the contracted for purchase and under some circumstances keep the buyer's down payment.

Accordingly, there has been a need for a system which increases the ability of a potential buyer with an old property for sale to both purchase a new property and sell the old property in a related transaction or scenario.

### SUMMARY OF THE INVENTION

It is an object of the invention to overcome the aforementioned limitations of the prior art.

It is another object of the invention to provide system operating as an exchange or market that enables users seeking to buy or sell a commercial item or commodity to list their respective item for sale in the exchange and to use the exchange to find items to purchase that are listed for sale by one or more like users, and linking all related buyers and sellers in a transaction scheme or scenario, and method for using same.

These objects and others are achieved through a method of organizing a trade that includes introducing into an electronic data processing system by a plurality of users information about items which they are willing to sell and searching in the electronic data processing system by the same users of the plurality of users information about items which they are willing to buy. In the event that one of the plurality of users finds an item in the electronic data processing system which the one user is willing to buy, generating by the electronic data processing system a connection between an item to sell, information about which the one user introduced into the electronic data processing system, and the item to buy, information about which the one user found in the electronic data processing system. Based on connections so formed, finding by the electronic data processing system in the plurality of users a plurality of groups of users, such that in each of the groups of users all items of all users of each of the groups can be sold and bought exclusively by all the users within each of the groups.

The invention also provides a system for organizing a trade. The system comprises an electronic data processing system. The electronic processing system includes means for introducing into the electronic data processing system, by a plurality of users, information about items which they are willing to sell, means for searching in the electronic data processing system by the same users of the plurality of users information about items which they are willing to buy and means for generating a connection between an item to sell, information about which was introduced by one user of said plurality of users, and an item to buy, information about which was found by the one user, in the event that the one user finds the item he is willing to buy. Means for finding a plurality of groups of users based on connections, such that in each of the groups all items of all users of each of the groups can be sold and bought exclusively by all the users within each of the groups.

In another embodiment, the invention provides a method of organizing trade, operable in a processor with memory storage, and preferably with access to data storage, and which is programmed to implement the method. Users should have a personal profile available to the processor implementing the method. Preferably, the user should be registered with a service that implements the method, or system. However, as long as the user logs in and creates at least a temporary file on the user, with user data, and the user's items for sale, formal registration is not necessary. The method includes listing, in the memory storage, items for sale in association with listing sellers, searching the memory storage, by buyers seeking to buy items listed for sale, selecting, by the buyers, items to buy of the items listed for sale and based on the selecting, automatically generating connections between the items selected to buy by the buyers, and items listed for sale by same buyers, in their roles as sellers.

In view of the user data, in the step of forming a connection, the system “knows” whether a buyer who makes a selection to buy has listed one, or more than one item for sale (in his/her role as seller). In the case where there is only one, it is simple--the system parses the user profile, identifies only one item, which then becomes part of the connection. But in the case where the buyer who selects an item to buy has previously listed multiple items for sale, in his/her role as seller, it is more complicated. The system parses the buyer's personal data or profile and realizes that this buyer has listed multiple items for sale. It then asks the buyer which of his/her listed items should be included in the instant transaction, i.e., linked to the item he/she selected to buy in the instant transaction. The system implements this questioning in the instant session, for example, by presenting a screen to the buyer listing all of the associated items, and requiring that a choice be made before the connection can be defined and the scenario/transaction move forward.

The method further includes linking generated connections to listing sellers associated with the connections' respective selected items to buy and establishing a trade scenario represented by a grouping of connections in which every seller, linked to every connection in the grouping by association with the connection's selected item to buy, has selected an item to buy listed for sale by said connection's buyer, wherein a buyer and a seller exist for every item in every connection in the grouping. Preferably, the processor comprises a computer server, database server or other processing system configured to implement a communication function that enables user computers to connect to and interact with the processing system during the steps of listing, searching and selecting.

For that matter, the method also preferably comprises one or more steps such as configuring the processor in accordance with particular trade schemes automatically communicating with all users involved in a trade scenario, upon selecting of a final or last item establishing the scenario, registering users prior to searching, which includes user authorization that upon establishing a scenario, an amount equal to the determined value of the item selected by the user to buy, in the role of buyer, is automatically proffered, and an amount equal to the determined value of the item listed by the buyer, in the role of seller, is automatically proffered and upon establishing the scenario, paying all sellers an amount equal to the value of their items that were selected to buy, and taking payment from same sellers in an amount equal to the value of the items listed for sale that were sold in the scenario.

### BRIEF DESCRIPTION OF THE DRAWINGS

Aspects of the invention will become apparent upon reading the following detailed description and upon reference to the accompanying drawings in which, like references may indicate similar elements:

FIG. 1 is a block diagram representing a system for organizing trade in accordance with the invention;

FIG. 1A depicts a system level depiction of a group of traders, where each must be both a buyer and a seller in any trade scenario according to the invention;

FIG. 2 is block diagram representing an electronic device programmed for implementing the a method of organizing trade;

FIG. 3 is a process flow diagram depicting a method of organizing trade; and

FIG. 4 is a computer readable medium upon which computer readable instructions may be stored, where upon execution of the instructions implements a method of the invention.

### DETAILED DESCRIPTION OF THE INVENTION

The following is a detailed description of example embodiments of the disclosed technology depicted in the accompanying drawings. The example embodiments are in such detail as to clearly communicate the disclosed technology. However, the amount of detail offered is not intended to limit the anticipated variations of embodiments. On the contrary, the intention is to cover all modifications, equivalents, and alternatives falling within the spirit and scope of the invention, as defined by the appended claims. The descriptions below are designed to make such embodiments obvious to a person of ordinary skill in the art.

The invention comprises an electronic system, for example, a computer processing system, preferably a computer server and/or a database server, which receives data related to items for sale, and organizes the data to facilitate trade. To be part of a trade, a user who wishes to buy an item first must have listed an item listed for sale. Upon selection of an item to buy, the selecting user (buyer's) listed item for sale become connected with the item selected to buy. The system calculates and creates circular scenarios or “matches” of a number of items, with a number of users or entities who want buy and sell the respective listed items. The circular scenario, or trade, is not fully defined until every item listed for sale by a user who also selects an item to buy has a buyer.

The inventive system and method obviates a need to spend hours and hours to find people who want to buy an “old property,” which transaction must be concluded prior to or at the time that the seller of the “old property” is able to complete a purchase of a new property. That is, instead of spending time and effort searching for buyers of an “old property” that must be sold to bankroll a purchase of a new property, the “old property” owner can concentrate his/her time and effort on searching for new properties to buy, as the trade or transaction in a selected “new property” is not completed, or consummated until a buy for the “old property” is ready will and able to buy.

The items for trade may be any item of value, for example, cars, trucks, boats, planes, commodities, stocks, artwork, commercial or residential real estate, even services without limitation.

Preferably, all items to be organized for sale are identified by identification (ID), which is a number or alphanumeric code assigned to the item at the time it is listed with the system, and its associated data are stored. For example, all items might be listed as members of an array, such as A, where the number associated with each is an integer index i. Hence each item and an array member, or ID, would be identified as Ai (e.g., A₂₃₆₅).

A connection links an item that a user selects to buy with the item the user lists for sale. Table 1 lists a plurality of connection between items for sale (Sell IDs) and items selected to buy (Buy IDs) by the users (sellers) who listed the item to sell. For example, a user who has listed item identified by number 156 for sale in a role of seller, has also selected two items to buy, items 1845 and 654, in a role as buyer. For that matter, a user may have multiple items listed for sale. Similarly, a user who has listed item 1845 for sale in a role as seller also has selected item 733 to buy in a role of buyer. Two users in their roles as sellers of items 434 and 733 have selected item 156 to buy in their respective roles as buyers. A user who has listed item 856 for sale in a role as seller also has selected item 34 to buy in a role of buyer and a user who has listed item 29876 for sale in a role as seller also has selected item 4296 to buy in a role of buyer., etc.

TABLE 1

| Sell ID | Buy ID |
|---|---|
| 156 | 1845 |
| 156 | 654 |
| 1845 | 733 |
| 434 | 156 |
| 733 | 156 |
| 856 | 34 |
| 29876 | 4216 |

The system implements a connection engine (CE) that calculates the scenario, or trades using the information entered by users and memory-stored, e.g., in a database. The connection engine processes selected items with the connected item for sale, for example:
156=>1845=>733=>156
   in the case of the example in Table 1. Since item the seller listing item 156 wants to purchase item 1845, the seller of item 1845 wants purchase item 733, as soon as the seller of item 733 selects to buy item 156, there is a scenario because each of the three items has a buyer and a seller, and every buyer and every seller have an item for sale and a selected item to buy in the transaction. As the database may store and list many classes of items, e.g., real Estate properties, cars, boats, books, antic, arts and even services that can be priced. As the reader can imagine, as there can be innumerable items in a database, some transactions will have only several items, but some transactions may be complex, having many items. For that matter, scenarios can be limited to individual classes, real estate, autos, etc.

Once a trade is established, i.e., a seller who in a role as a buy selects to buy an item of listed for sale by another who has already selected an item for sale, which closes the trade because all sellers have a buyer for their items, in the grouping of items, and the items listed for sale by all the buyers (in their respective roles as sellers), have buyers all in the transaction-defined closed group. Then, the system sends a message to all users who are members of a scenario, or trade transaction. The users may then execute the trade or system can automatically execute this financial transaction, where all users have enough credit on a system. As such, the system does not need “matching criteria” or a “base” item for which scenario is created. All items are equal in the system, and the number of scenarios depends on number of items and connections stored in a database.

In an embodiment, a number of scenarios is limited by number of items to be included, e.g., scenarios that have less then 10 trading items. As the number of items included in a scenario decreases, the probability of executing a trade for the scenario increases. This system can provide or not provide support for execution created scenarios.

There may be many ways to select items for a scenario. For example, the system may operate on SQL statement to create the scenarios. An important requirement to enable the system to calculate scenarios is the structure of listed properties in a field, and the connections comprising information about what item is buying what item Ai buying item Aj. If this field exists, the scenario may be created.

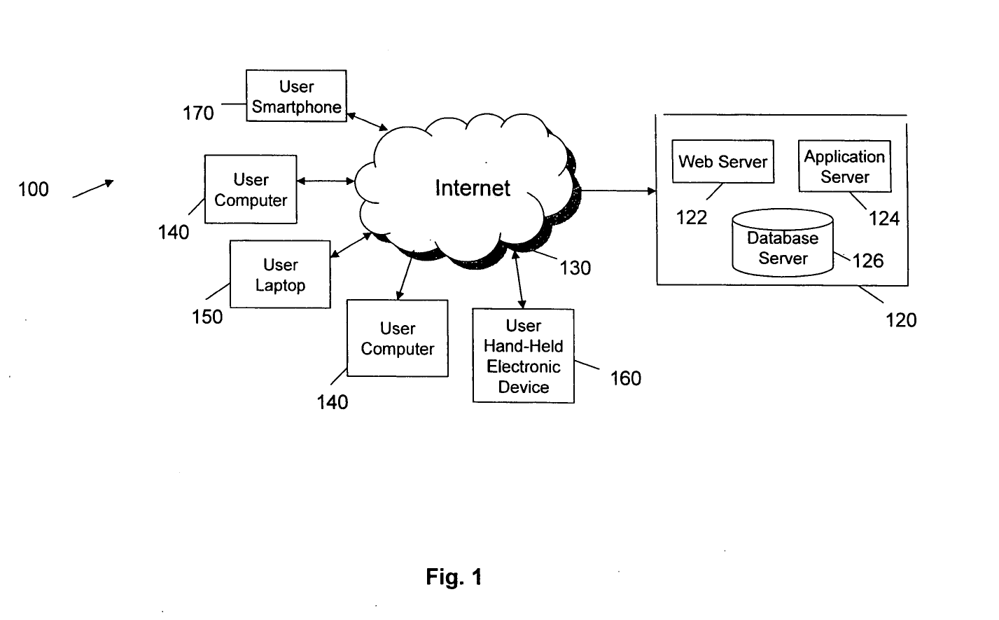

FIG. 1 illustrates one form of a system, or network, for organizing trade 100, according to the invention. FIG. 1 A depicts a system level depiction of a group of traders, where each must be both a buyer and a seller in any trade scenario according to the invention

The system or network may be managed as a business by an organization. As shown in FIG. 1, the system or network for organizing trade includes a processing system 120 that is interconnected to a number of users though the Internet 130. Processing system 120 comprises web server 122, application server 124 and database server 126, which provide for inventive operation. Users may connect to the processing system 120 via user computers 140, user laptops 150, user hand-held devices 160, user smartphones 170, telephones, PDAs, notebook computers, without limitation, to register to trade, including providing personal and/or financial information, to log in, to enter information about the items they wish to list for sale, to search for items to buy, to select items to buy, to send and receive communications to the system, and other users, to execute financial transactions such as payment for a purchase, etc.

The users (by their respective electronic devices) may connect directly to the processing system 120, for example, in a network (not shown), wirelessly, via a telephone exchange or satellite communication system, or indirectly through the Internet 130. The processing system 120 may include internal memory storage (not expressly shown), external memory storage 180 to which it is directly connected, or connected via a network, or to which it is connected via the Internet. The processing system 120 may be a database programmed to implement the method of the invention.

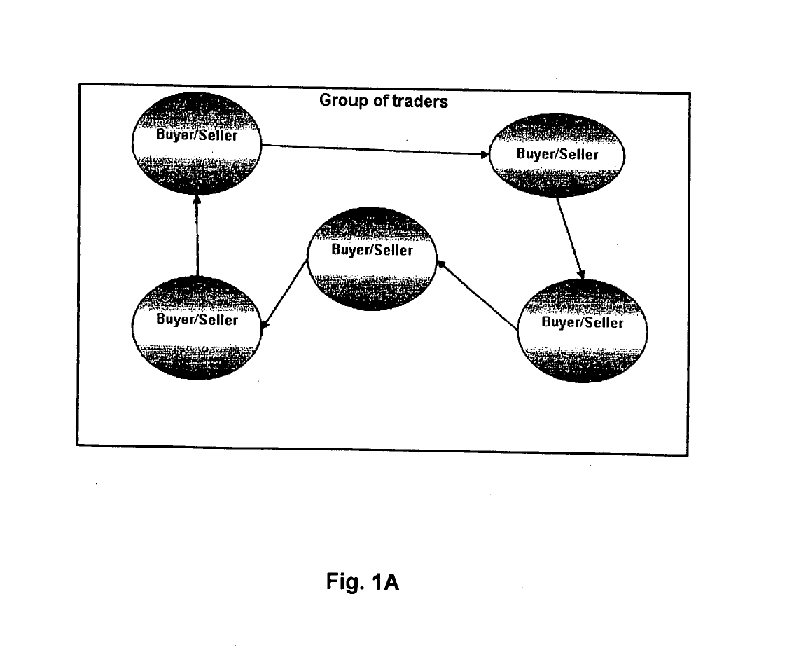

FIG. 2 illustrates a typical hardware configuration of electronic device, such as a database server 126 of processing system 120, for implementing the method of organizing trade in accordance with the invention. Database server 126 preferably has at least one processor or central processing unit (CPU) 212. CPUs 212 are interconnected via a system bus 214 to a random access memory (RAM) 216, read-only memory (ROM) 218, input/output (I/O) adapter 220 (for connecting peripheral devices such as disk units 222 and tape drives 224 to the bus 214), user interface adapter 226 (for connecting a keyboard 228, mouse 230, speaker 232, microphone 234, and/or other user interface device to the bus 214), a communications adapter 236 for connecting an information handling system to a data processing network (either wireline or wireless), the Internet, an Intranet, a personal area network (PAN), etc., and a display adapter 238 for connecting the bus 214 to a display device 240 and/or printer 242 (e.g., a digital printer or the like).

In addition to the hardware/software environment described above, a different aspect of the invention includes a computer-implemented method for performing the above method. As an example, this method may be implemented in the particular environment discussed above. Such a method may be implemented, for example, by operating a computer, as embodied by a digital data processing apparatus, to execute a sequence of machine-readable instructions. These instructions may reside in various types of signal-bearing storage media.

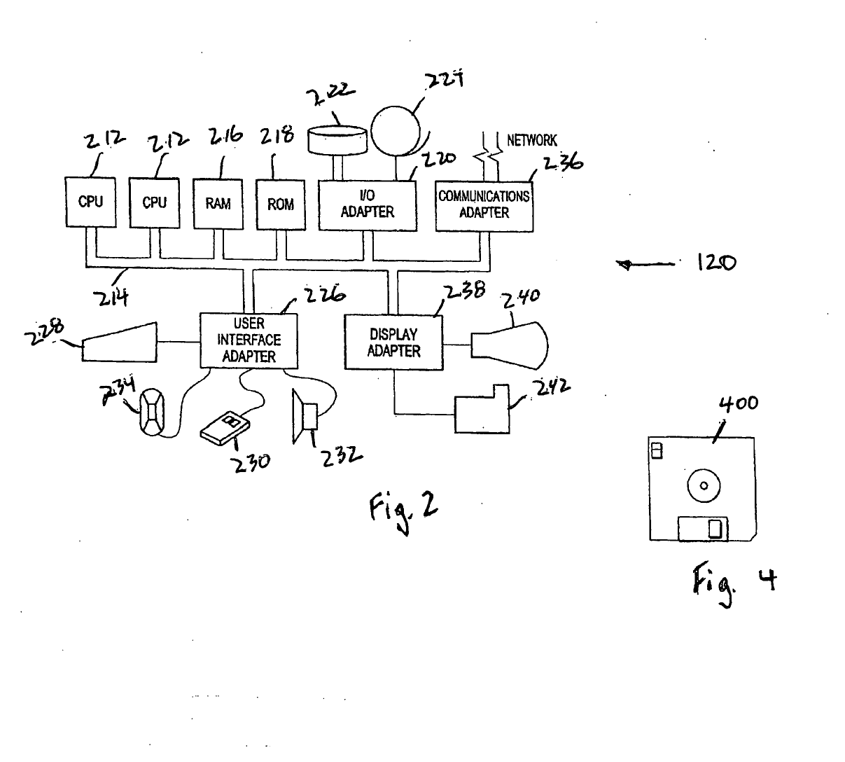

FIG. 3 illustrates one method 300 of organizing trade (process flow), operable in an electronic device with memory storage (such as a database processor 126 of processing system 120), which is programmed to implement the method in the form of certain steps is disclosed. Block 205 represents a step of users connecting to the s processing system and registering to trade. Users must connect to and log on the processing system in order to list an item for sale, search for items to buy, select, etc., as known by those with skill in the art. Users should have a personal profile available to the processor implementing the method. Preferably, the user should be registered with a service that implements the method, or system. However, as long as the user logs in and creates at least a temporary file on the user, with user data, and the user's items for sale, formal registration is not necessary.

Block 310 represents a step of listing, in the memory storage, items for sale in association with listing sellers. Several steps or actions must take place prior to the step of listing, in order to render the system operational. For example, the system must be configured to operate for a particular service, and therefore the processing system must be incorporated and accessible in the organization's network, or at linked to the organization's server in such as way to enable buyers and sellers electronic access to the processing system 120, and allow the processing system 120 the ability to communicated directly to the users. Hence, users (through their browsers) must connect to a user's interface made available by the processing system, in a communication session.

Block 320 represents a step of searching the memory storage (in a database or other means for storing data), the searching carried out by buyers (connected to the processing system) seeking to buy items listed for sale. As mentioned, these potential buyers become part of a trade, or transaction, where they, in their role as sellers, have listed an item for sale that must also be part of the trade. Block 330 represents as step of selecting, by said buyers, items to buy of said items listed for sale. In view of the user data, in the step of forming a connection, the system “knows” whether a buyer who makes a selection to buy has listed one; or more than one item for sale (in his/her role as seller). In the case where there is only one, it is simple--the system parses the user profile, identifies only one item, which then becomes part of the connection. But in the case where the buyer who selects an item to buy has previously listed multiple items for sale, in his/her role as seller, it is more complicated. The system parses the buyer's personal data or profile and realizes that this buyer has listed multiple items for sale. It then asks the buyer which of his/her listed items should be included in the instant transaction, i.e., linked to the item he/she selected to buy in the instant transaction. The system implements this questioning in the instant session, for example, by presenting a screen to the buyer listing all of the associated items, and requiring that a choice be made before the connection can be defined and the scenario/transaction move forward.

Step 340 represents as step of based on the selecting, automatically generating connections between said items selected to buy by said buyers, in their roles as buyers, and items listed for sale by same said buyers, in their roles as sellers. Block 350 represents a step of linking generated connections to listing sellers associated with said connections' respective selected items to buy. That is, every item selected to buy by a user in their role as a buyer is linked in the connection to the item listed for sale by the buyer, in their role as a seller, which is a condition precedent to enable a user to participate in a trade or transaction.

Block 360 represents a step of establishing a trade scenario represented by a grouping of connections in which every seller, linked in a connection in said grouping by association with said connection's selected item to buy, has selected an item to buy listed for sale by said connection's buyer, wherein a buyer and a seller exist for every item in every connection in said grouping. Hence, every connection's item for sale is listed in another connection, in the grouping of connections comprising a trade scenario or transaction, as an item selected to buy, and no item linked in a transaction stands outside the scenario, or list of linked connections. Put another way, when every associated item has a buyer, and every buyer's associated item has a seller, all linked by being in the grouping of connections, the trade scenario is established. While not shown in FIG. 3, once the scenario is established, or closed, the respective users may be contacted to implement the actual purchases, the actual purchases may be executed automatically, including that the system automatically interacts with the users' banks, etc., based on the way the system is configured to meet an organization's particular requirements.

Thus, these aspects of the present invention is directed to a programmed product, comprising signal-bearing storage media tangibly embodying a program of machine-readable instructions executable by a digital data processor incorporating the CPU 212 and hardware above, to perform the method of organizing trade of the invention.

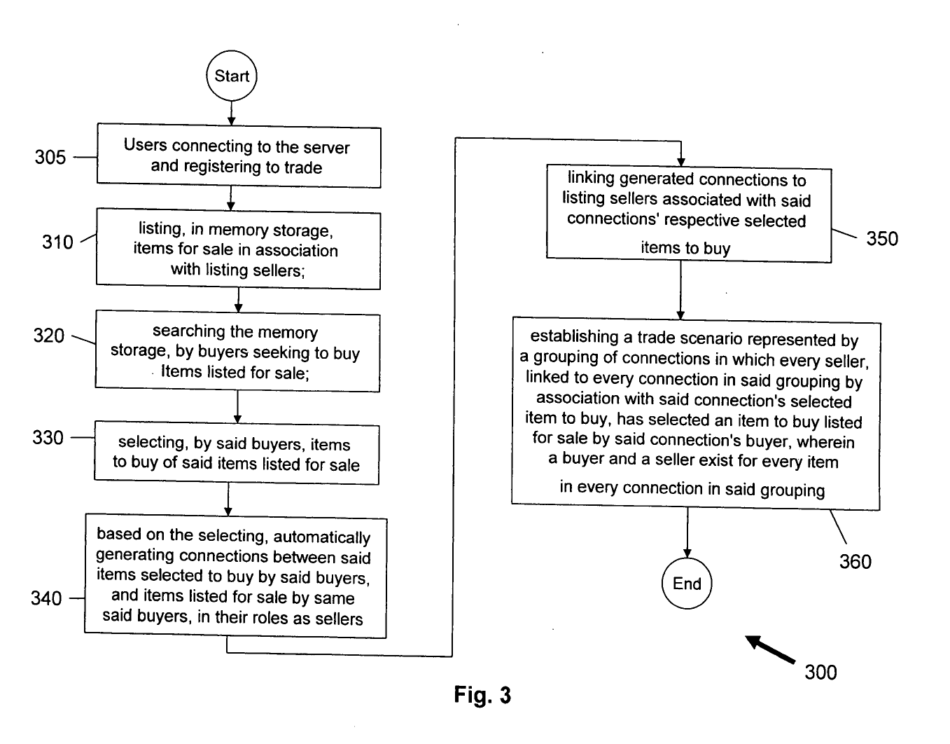

This signal-bearing storage media may include, for example, a RAM contained within the CPU 212, as represented by the fast-access storage for example. Alternatively, the instructions may be contained in another signal-bearing storage media, such as a magnetic data storage diskette 400 (FIG. 4), directly or indirectly accessible by the CPU 212.

Whether contained in the diskette 400, or some other computer readable medium, the processing system 120, or database server 126 comprising CPU 212, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape). Other suitable signal-bearing media include memory devices in transmission media and instructions stored in formats such as digital and analog and memory devices in communication links and wireless. In an illustrative embodiment of the invention, the machine-readable instructions may comprise software object code. It should also be obvious to one of ordinary skill in the art that the technique of the present invention could be implemented on a network in a variety of configurations.

Hence, the invention includes a computer program product and a set of processor readable instructions that when executed by a processor execute a method for organizing trade.

Although examples of the invention have been shown and described, it would be appreciated by those skilled in the art that changes may be made in these embodiments without departing from the principles and spirit of the invention, the scope of which is defined in the following claims and their equivalents.

What is claimed is:

1. A method of organizing a trade, comprising the steps of:
introducing into an electronic data processing system by a plurality of users information about the users and items which they are willing to sell;
searching in said electronic data processing system by said same users of said plurality of users' information about items which they are willing to buy;
in the event that one of said plurality of users finds an item in said electronic data processing system which said one user is willing to buy, generating by said electronic data processing system a connection between an item to sell, information about which said one user introduced into said electronic data processing system, and the item to buy, information about which said one user found in said electronic data processing system; and
based on connections so formed, finding by said electronic data processing system in said plurality of users a plurality of groups of users, such that in each of said groups of users all items of all users of each of said groups can be sold and bought exclusively by all said users within each of said groups.

2. The method as set forth in claim 1, further comprising a step of communicating electronically to all users in said groups of users that all items can be sold and bought.

3. The method as set forth in claim 1, further comprising a step of completing a transaction by which all said items are sold and bought.

4. A computer program product including a set of processor readable instructions that when executed by the processor execute a method of organizing a trade, as set forth in claim 1.

5. A system for organizing a trade, comprising:
an electronic data processing system;
means for introducing into said electronic data processing system, by a plurality of users, information about the users and items which they are willing to sell;
means for searching in said electronic data processing system by said same users of said plurality of users information about items which they are willing to buy, means for generating a connection between an item to sell, information about which was introduced by one user of said plurality of users, and an item to buy, information about which was found by said one user, in the event that said one user finds said item he is willing to buy, and
means for finding a plurality of groups of users based on connections, such that in each of said groups all items of all users of each of said groups can be sold and bought exclusively by all said users within each of said groups.

6. The system set forth in claim 5, further comprising means for organizing a transaction by which all items that can be bought and sold in association with said groups of users are sold.

7. A method of organizing trade, operable in a processor with memory storage and programmed to implement the method, comprising steps of:
listing, in the memory storage, items for sale in association with listing sellers;
searching the memory storage, by buyers seeking to buy items listed for sale;
selecting, by said buyers, items to buy of said items listed for sale; and
based on the selecting, automatically generating connections between said items selected to buy by said buyers, and items listed for sale by same said buyers, in their roles as sellers;
linking generated connections to listing sellers associated with said connections’ respective selected items to buy; and
establishing a trade scenario represented by a grouping of connections in which every seller, linked to every connection in said grouping by association with said connection's selected item to buy, has selected an item to buy listed for sale by said connection's buyer, wherein a buyer and a seller exist for every item in every connection in said grouping.

8. The method as set forth in claim 7, further including a step of registering users who wish to trade.

9. The method as set forth in claim 1, wherein the step of listing includes that the user electronically connect to the processor with memory storage and provide personal data including one or more items that the user wishes to sell, and wherein the step of generating connections includes searching the personal data of the buyers selecting to buy, to determine whether there is one or more than one items listed for sale by said buyer, where if there is only one the connection is formed but if there is more than one the buyer is queries to determine which of the multiple items should be included in the instant connection formed by the instant selection to buy.

10. The method as set forth in claim 8, wherein the step of listing requires users to login to list and item for sale, in association with their role as a seller or to select an item to buy, in association with their role as a buyer.

11. The method as set forth in claim 7, wherein the processor comprises a computer server configured to implement a communication function that enables user computers to connect to and interact with the server during the steps of listing, searching and selecting.

12. The method as set forth in claim 7, further comprising a step of configuring the processor in accordance with particular trade schemes.

13. The method as set forth in claim 7, wherein said processor with memory storage comprises, or is connected to a database.

14. The method as set forth in claim 7, further comprising a step of automatically communicating with all users involved in a trade scenario, upon selecting of a final or last item establishing the scenario.

15. The method as set forth in claim 7, further comprising the step of:
registering users prior to searching, which includes user authorization that upon establishing a scenario, an amount equal to the determined value of the item selected by the user to buy, in the role of buyer, is automatically proffered, and an amount equal to the determined value of the item listed by the buyer, in the role of seller, is automatically proffered.

16. The method as set forth in claim 15, further comprising:
upon establishing the scenario, paying all sellers an amount equal to the value of their items that were selected to buy, and taking payment from same sellers in an amount equal to the value of the items listed for sale that were sold in the scenario.

17. A computer program product including a set of processor readable instructions that when executed by a processor execute a method of organizing trade, as set forth in claim 7.
